(19) United States
(12) Patent Application Publication
(10) Pub. No.: US 2006/0000261 A1
(43) Pub. Date: Jan. 5, 2006

(54) Apparatus and method for elevated temperature weld testing

(76) Inventor: Louis J. Wardlaw III, Houston, TX (US)

Correspondence Address: Beirne, Maynard & Parsons, L.L.P., Ste. 2500, 1300 Post Oak Blvd., Houston, TX, 77056-3000, US

(21) Appl. No.: 10/600,921

(22) Filed: Jun. 20, 2003

(51) Int. Cl. G01M 3/22; G01M 3/28

(52) U.S. Cl. 73/40.7; 73/46

(57) ABSTRACT

In a method for testing the integrity of welds at elevated temperatures, a pressurized mixture of a gaseous environmentally safe composition is injected in an area between the inner and outer weld of a terminal flange welded to a tubular pipe section or casing. The pressurized composition includes a marker sub-composition which is detected by a detection apparatus which scans the weld. The pressure of the gas composition is also monitored to observe losses in pressure indicative of flaws in the welds. The integrity of the welds is tested at elevated temperature permitting remedial repairs to be made without reheating the tubular pipe or casing.

### BACKGROUND OF THE DISCLOSURE

This invention is directed to a method for testing the integrity of welds, particularly, a process for pressure testing the integrity of welds at elevated temperatures using a pressurized gas composition to locate flaws which may be present in the welds.

In drilling an oil well, it is often necessary to install wellheads of various sizes of large diameter pipe. Several sizes of pipe or casing may be installed in a well. The well might include, as an example, a 36 inch driver pipe. There may also be a 20 inch casing, 13 and ⅜ inch casing and 9 and ⅝ inch casing. It is necessary to install a terminate flange or wellhead at every change of size. The wellhead is typically installed by first cutting the casing, preheating the casing, then welding the wellhead in place. The wellhead is necessary to mount other equipment or to otherwise install the next casing string. Often, this procedure requires cutting a very thick wall casing, even in the range of 11/2 inch thick and thereafter making a multi-pass welded bead to attach the wellhead. To obtain a quality weld, the temperature of the pipe in the area of the weld must be raised to the welding temperature of the pipe or casing prior to actual welding. A typical welding temperature for pipe or casing material is in the range of 500.degree. F. Consequently, a tremendous amount of preheating is required to obtain a quality weld.

Preheating is often a problem, particularly for drilling rigs located at sea. In inclement weather, wind shields must be installed and a number of welders will position their torches on the casing and wellhead to preheated for perhaps 4 to 6 inches below the casing head in length to perhaps 500.degree. F. This is difficult and time consuming.

Certain devices have been provided heretofore to serve as preheaters. In U.S. Pat. No. 4,507,082 to Wardlaw, the inventor of the present disclosure, a preheating apparatus is described which heats the casing and wellhead from the interior. Other preheater devices are also available as typified by the patent of Jaeger, U.S. Pat. No. 3,082,760.

While a number of apparatus have been developed for preheating the casing and wellhead to welding temperatures, relatively little (has been done in the area of testing or proving the integrity of the welds. The integrity of the welds connecting the wellhead or terminal flange to the casing, however, is critical to the safe completion of a well. When drilling an oil well, tremendous pressures may be encountered requiring that all connections or welds be leak-proof. This is particularly true for connection of the wellhead which includes other apparatus mounted thereon.

It has long been recognized that proving the integrity of welds is desirable and necessary when drilling an oil well. To this end, terminal flanges or wellheads are provided with an internal circumferential groove, which groove is located between the inner and outer weld upon welding the wellhead to the casing. A port provides access to the groove. Thus, the conventional method for testing the integrity of welds includes the connection of a pressure pump to the port and pumping fluid into the groove and observing any pressure losses. Fluids such as oil, water, or antifreeze are typically used. Prior to injection of the fluid, however, the casing must be permitted to cool to approximately 200.degree. F. or less to avoid thermal shock at the weld. Rapid cooling can damage the metallurgy of the casing and wellhead material. The customary method of proving the integrity of welds is to permit the wellhead casing to gradually cool to a temperature of 200.degree. F. or less prior to injection of a fluid into the test groove to verify that no flaws or cracks are present in the welds. This procedure is very time consuming and in the event that flaws in the weld are located, the wellhead and casing must be reheated to the welding temperature to repair the flaws or cracks located in the initial welds. In addition, the test groove must be cleaned of injection fluid prior to reheating.

In U.S. Pat. No. 4,596,135, issued to the present applicant, discloses a testing procedure and system which uses a marker gas of conventional nature, such as Freon. However, in recent years, Freon and other chlorine-containing halogenic gaseous substances have been prohibited as refrigerants and other commercialized uses by many nations in the world because of the belief that it destroys the protective ozone belt in the atmosphere. Several other gas compositions have been suggested for many commercial applications, but their overall use and acceptance has been slow due to several disadvantages, not the least of which is the corrosive side effect that some of the newer gas compositions may have when exposed to some exotic metals sometimes found in industrialized applications.

The process and system of the present disclosure overcomes the disadvantages of prior art weld verification techniques where gases which have been proven to be environmentally dangerous have been utilized. The process of the present disclosure may be carried out at elevated temperatures thereby eliminating the time consuming cool down period prior to testing and the reheating period in the event remedial repairs to the welds required and by incorporating a nonchloride-, non-chlorine-containing gas constituent as a marker.

### SUMMARY OF THE INVENTION

The present disclosure is directed to a system and process for verifying the integrity of welds at elevated temperatures. The system comprises a pressurized container of a gas composition for connection to a wellhead injection port. The gas composition is injected through the injection port at the elevated welding temperature and at sufficient pressure to adequately test the integrity of the welds, thereby locating the presence of any cracks or leaks. The gas composition includes a marker gas sub-composition of a non chlorine-containing hydrocarbon which is detected by a detection apparatus passed over the weld of interest. Leaks or other flaws in the welds may also be observed by monitoring the pressure gauge on the gas container for any loss of pressure which would indicate the presence of a leak.

### BRIEF DESCRIPTION OF THE DRAWINGS

FIG. 1 is a cross-sectional environmental view illustrating the system of the present disclosure connected to test the integrity of the welds connecting a wellhead to a casing; and

FIG. 2 is an enlarged cross-sectional view of the welds and injection port illustrating the fluid communication established between the injection port and the welds.

### DETAILED DESCRIPTION OF THE PREFERRED EMBODIMENT

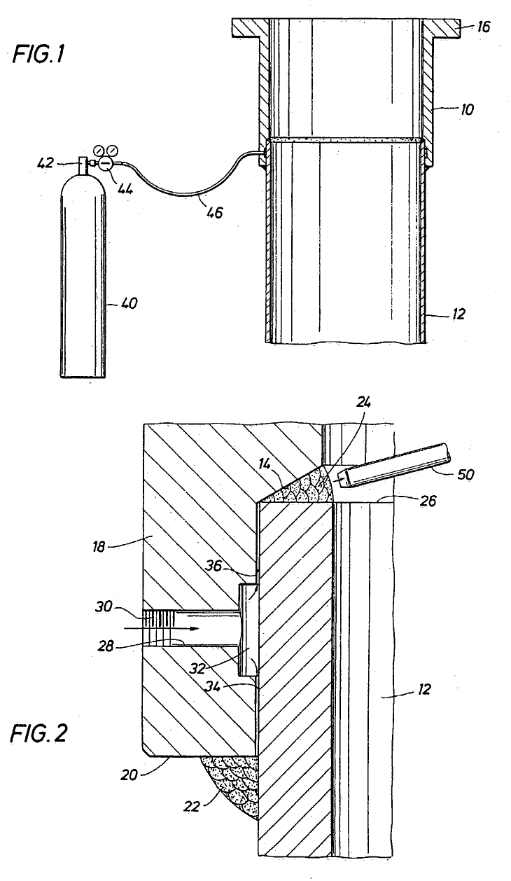

Attention is first directed to FIG. 1 of the drawings which shows the general configuration of the system for verifying the integrity of the welds connecting a wellhead or terminal flange 10 to a casing 12. Assume, for purposes of illustration, that the casing 12 is a large diameter casing having a wall thickness conforming with industry standards. The casing 12 can range from ½ inch thick to about 11/2 inch or greater. The wellhead 10 is connected to the casing 12. The wellhead 10 is constructed with an internal shoulder 14 to abut the end of the casing 12. The wellhead 10 is generally cylindrical and open at each end. A peripheral, outwardly extending flange 16 is provided about the upper end of the wellhead 10 for connection to other equipment. At the opposite end of the wellhead 10, a cylindrical portion 18 extends from the shoulder 14 which telescopes over the end of the casing 12. The end or edge of the cylindrical portion 18 is defined by a flat circumferential surface 20. A multi-pass bead 22 is formed joining the surface 20 and the external surface of the casing 12. Inside a finish bead 24 is formed joining the end 26 of the casing 12 to the shoulder 14 of the wellhead 10. The bead 22 is formed first to fully and completely anchor the wellhead 10 to the casing 12. The weld 22 is a high quality weld, subject to 100% inspection, and must usually be formed in many passes.

Prior to welding, it is very important to preheat the casing 12 to a specified temperature, typically in the range of 500.degree. F. Failure to evenly preheat the casing 12 may damage the welds 22 and 24. Likewise, rapid cooling after the welds 22 and 24 have been formed may crack or fracture the welds 22 and 24.

As previously mentioned, it is a well-known practice to test the integrity of the welds 22 and 24. To this end, the cylindrical portion 18 is provided with an injection port 28. The injection port 28 is internally threaded at 30 and opens into a circumferential groove 32 formed on the internal cylindrical surface of the cylindrical portion 18. When the cylindrical portion 18 is telescoped over the end of the casing 12 as shown in FIG. 2, the groove 32 and casing 12 form a fluid chamber or gap therebetween.

The wellhead 10 and casing 12 are sized so that when telescoped together, a metal-to-metal contact is established between the internal surface of the cylindrical portion 18 and the external surface of the casing 12. For illustrative purposes, however, gaps 34 and 36 are shown in FIG. 2 to illustrate that fluid communication is established between the welds 22, 24 and the fluid chamber or groove 32.

Referring now to FIG. 1, the pressurized container 40 of the system of the present disclosure is shown connected to the injection port 28. The container 40 is a high pressure gas canister provided with a valve 42, which in turn is connected to pressure gauges 44. A high pressure hose or tubing 46 is provided with a threaded connector at one end for connection to the injection port 28 at 30, thereby establishing fluid communication between the pressurized container 40 and the weld beads 22 and 24.

The pressurized container 40 contains a mixture of gas compositions. The gas mixture provides sufficient pressure within industry standards, typically in the range of 150-1500 psi to test for any flaws or cracks which may be present in the weld beads 22 and 24. The gas mixture compositions also include a marker gas sub-composition which may be easily detected as it leaks through the welds 22 and 24. By way of example and for illustrative purposes only, compressed nitrogen may be used to supply the pressure necessary for testing the integrity of the welds 22 and 24.

In recent years, there has been considerable attention directed to the use of certain chlorofluorocarbons (CFC's) and hydrochlorofluorocarbons (HCFC's) because they are believed to attack and deplete the earth's ozone layer. Accordingly, the present invention contemplates the use of a marker gas that does not contain the undesired chlorinated components that are harmful to the ozone belt. The invention contemplated the use as a marker, and in combination with the other components herein, a non-chlorine-containing marker composition, such as a single fluorinated hydrocarbon or an azeotropic or azeotrobe-like composition that includes one or more fluorinated hydrocarbons. The present invention relates to the use of non-chlorine-containing marker probe components such as compositions of hexafluoropropane and a hydrocarbon having from 1 to 5 carbon atoms or dimethyl ether. Examples of hydrocarbons having from 1 to 5 carbon atoms include butane, cyclopropane, isobutane, propane. Examples of the inventive compositions include compositions of 1,1,2,2,3,3-hexafluoropropane (HFC-236ca) and butane, cyclopropane, isobutane or propane; 1,1,1,2,2,3-hexafluoropropane (HFC-236cb) and butane, cyclopropane, dimethyl ether (DME), isobutane or propane; 1,1,2,3,3,3-hexafluoropropane (HFC-236ea) and butane, cyclopropane, DME, isobutane or propane; and 1,1,1,3,3,3-hexafluoropropane (HFC-236fa) and DME, butane, cyclopropane, isobutane or propane. Further, the invention relates to the discovery of binary azeotropic or azeotrope-like compositions comprising effective amounts of 1,1,2,2,3,3-hexafluoropropane and butane, cyclopropane, isobutane or propane; 1,1,1,2,2,3-hexafluoropropane and butane, cyclopropane, DME, isobutane or propane; 1,1,2,3,3,3-hexafluoropropane and butane, cyclopropane, DME, isobutane or propane; and 1,1,1,3,3,3-hexafluoropropane and DME, butane, cyclopropane, isobutane or propane to form an azeotropic or azeotrope-like composition.

By “azeotropic” composition is meant a constant boiling liquid admixture of two or more substances that behaves as a single substance. One way to characterize an azeotropic composition is that the vapor produced by partial evaporation or distillation of the liquid has the same composition as the liquid from which it was evaporated or distilled, that is, the admixture distills/refluxes without compositional change. Constant boiling compositions are characterized as azeotropic because they exhibit either a maximum or minimum boiling point, as compared with that of the non-azeotropic mixtures of the same components.

By “azeotrope-like” composition is meant a constant boiling, or substantially constant boiling, liquid admixture of two or more substances that behaves as a single substance. One way to characterize an azeotrope-like composition is that the vapor produced by partial evaporation or distillation of the liquid has substantially the same composition as the liquid from which it was evaporated or distilled, that is, the admixture distills/refluxes without substantial composition change. Another way to characterize an azeotrope-like composition is that the bubble point vapor pressure and the dew point vapor pressure of the composition at a particular temperature are substantially the same.

It is recognized in the art that a composition is azeotrope-like if, after 50 weight percent of the composition is removed such as by evaporation or boiling off, the difference in vapor pressure between the original composition and the composition remaining after 50 weight percent of the original composition has been removed is less than 10 percent, when measured in absolute units. By absolute units, it is meant measurements of pressure and, for example, psia, atmospheres, bars, torr, dynes per square centimeter, millimeters of mercury, inches of water and other equivalent terms well known in the art. If an azeotrope is present, there is no difference in vapor pressure between the original composition and the composition remaining after 50 weight percent of the original composition has been removed.

Therefore, included in this invention are non-chlorine-containing marker composition probes of effective amounts of 1,1,2,2,3,3-hexafluoropropane and butane, cyclopropane, isobutane or propane; 1,1,1,2,2,3-hexafluoropropane and butane, cyclopropane, DME, isobutane or propane; 1,1,2,3,3,3-hexafluoropropane and butane, DME, cyclopropane, isobutane or propane; and 1,1,1,3,3,3-hexafluoropropane and DME, butane, cyclopropane, isobutane or propane such that after 50 weight percent of an original composition is evaporated or boiled off to produce a remaining composition, the difference in the vapor pressure between the original composition and the remaining composition is 10 percent or less.

For compositions that are azeotropic, there is usually some range of compositions around the azeotrope that, for a maximum boiling azeotrope, have boiling points at a particular pressure higher than the pure components of the composition at that pressure and have vapor pressures lower at a particular temperature than the pure components of the composition at that temperature, and that, for a minimum boiling azeotrope, have boiling points at a particular pressure lower than the pure components of the composition at that pressure and have vapor pressures higher at a particular temperature than the pure components of the composition at that temperature. Boiling temperatures and vapor pressures above or below that of the pure components are caused by unexpected intermolecular forces between and among the molecules of the compositions, which can be a combination of repulsive and attractive forces such as van der Waals forces and hydrogen bonding.

The range of compositions that have a maximum or minimum boiling point at a particular pressure, or a maximum or minimum vapor pressure at a particular temperature, may or may not be coextensive with the range of compositions that are substantially constant boiling. In those cases where the range of compositions that have maximum or minimum boiling temperatures at a particular pressure, or maximum or minimum vapor pressures at a particular temperature, are broader than the range of compositions that are substantially constant boiling according to the change in vapor pressure of the composition when 50 weight percent is evaporated, the unexpected intermolecular forces are nonetheless believed important in that the refrigerant compositions having those forces that are not substantially constant boiling may exhibit unexpected increases in the capacity or efficiency versus the components of the refrigerant composition.

The marker gas used and described herein and immediately above is easily detectable at very low concentrations, may be utilized in the pressurized gas mixture of the system of the present disclosure. It is understood, however, that other gases within the scope of the claims herein may also be used to form the gas mixture. The system of the present invention requires only that the gas mixture provide sufficient pressure and that the marker gas composition be detectable at relatively small concentrations.

Other FREON R12 non-chloine-containing replacements are contemplated for use in the present invention. Many of these replacements are useful as refrigerants. For example, DURACOOL 12a, commercially available from Duracool Limited, Edmonton, Alberta, Canada may be used in the marker composition and in the present invention. Another acceptable component in the marker composition is a refrigerant commonly referred to as R134. Still other useful components for the marking composition include HC-12a and OZ-12 (each being a registered trademark of OZ Technology, Inc., which has been generically identified by the Environmental Protection Agency as “Hydrocarbon Blend B”.

To illustrate the benefits of the system described herein, it will be recalled that the pressurized container 40 is connected to the injection port 28 upon completion of the weld beads 22 and 24. The temperature of the wellhead 10 and casing 12 is substantially near the welding temperature, having cooled only slightly while the connection at 30 is made. The valve 42 is opened permitting compressed gas from the canister 40 to be injected into the groove 32. The valve 42 is closed and the pressure gauges 44 are monitored and loss of pressure is noted indicating that a flaw is present in the welds 22 and 24. The pressure gauges 44 provide the first indication of a flaw in the weld beads. Each of the weld beads 22 and 24, however, is also checked with a marker gas detecting apparatus. A probe 50 connected to the marker gas composition detecting apparatus is passed over the welds 22 and 24 for detecting the marker gas composition passing through the welds 22 and 24. The detecting apparatus is calibrated to register very small concentrations of the marker gas composition, even in the range of parts per billion. Thus, the system of the present disclosure provides an effective means for locating flaws in the weld beads 22 and 24 at an elevated temperature substantially near the welding temperature.

If a leak is detected, the location and extent of the flaw can be determined by passing the probe 50 over the welds 22, 24 and observing the concentration of the marker gas registered by the marker gas composition detecting apparatus. The flaw is then ground out and remedial work is done while the wellhead 10 and casing 12 are still at the welding temperature. If no leaks are detected, the welds 22 and 24 may be conveniently retested when the wellhead temperature drops to ambient levels insuring that no flaws have developed in the well beads 22 and 24 during the cooling process.

While the foregoing is directed to the preferred embodiment of the present invention, other and further embodiments of the invention may be devised without departing from the basic scope thereof, and the scope thereof is determined by the claims which follow.

What is claimed and desired to be secured by Letters Patent is:

1. A method of detecting flaws in a weld connecting a wellhead to a casing, the method comprising the steps of:
(a) connecting a source of pressurized gas composition to an injection port in the wellhead in fluid communication with the weld, said pressurized gas composition comprising a gas mixture including a marker sub-composition comprising at least a marking amount of a non chlorine-containing hydrocarbon;
(b) injecting said pressurized gas composition including said hydrocarbon through said injection port while the weld is at an elevated temperature;
(c) monitoring the source of pressurized gas composition for detecting losses in pressure; and
(d) passing a non chlorine-containing hydrocarbon gas detector probe over the weld for detecting non chlorine-containing hydrocarbon gas leaking through the weld.

2. The method of claim 1 wherein said marker sub-composition is 1,1,1,2-tetrafluoroehtane.

3. The method of claim 1 wherein said marker sub-composition gas is a halogen-containing hydrocarbon and is free of Refrigerant 12.

4. The method of claim 1 wherein fluid communication is established between said pressurized gas composition and the weld while the temperature of the wellhead is at substantially 500.degree. F.

5. A system for determining flaws in a weld connecting a terminal flange to a pipe, comprising:
(a) a source of pressurized gas composition for connection to a wellhead injection port establishing fluid communication between said source of pressurized gas composition and said weld;
(b) a gas detector probe for detecting a non chlorine-containing hydrocarbon gas leaking through said weld; and
(c) wherein fluid communication is established between said pressurized gas composition and said weld while the weld is maintained at an elevated welding temperature for detecting flaws in said weld at said elevated temperature.

6. The system of claim 5 wherein said pressurized gas' composition comprises a gas sub-composition including a marker gas of 1,1,1,2-tetrafluoroethane.

7. The system of claim 5 wherein said marker gas is a non chlorine-containing hydrofluorocarbon.

8. The system of claim 6 wherein said marker gas is free of Refrigerant 12.
